(19) United States
(12) Patent Application Publication
(10) Pub. No.: US 2025/0050554 A1
(43) Pub. Date: Feb. 13, 2025

(54) SYSTEM, METHOD, AND COMPUTER PROGRAM PRODUCT FOR INTRODUCING FOAM INTO A CONFINED SPACE

(71) Applicant: Wall to Wall, LLC, Hayward, CA (US)

(72) Inventors: Shai SHACHRUR, Givat Ela (IL); Lisong ZHOU, Fremont, CA (US); Israel Jay KLEIN, Kfar Saba (IL)

(73) Assignee: Wall to Wall, LLC, Hayward, CA (US)

(21) Appl. No.: 18/718,000

(22) PCT Filed: Dec. 7, 2022
(86) PCT No.: PCT/IL2022/051298

§ 371 Date: Jun. 7, 2024

Related U.S. Application Data
(60) Provisional application No. 63/286,688, filed on Dec. 7, 2021.

(51) Int. Cl. B29C 44/60; B29C 44/18

(52) U.S. Cl. CPC B29C 44/60; B29C 44/18

(57) ABSTRACT

A fabrication method comprising providing a digital file storing metadata describing an object having an interior and providing a hardware processor which is configured to access foam specification data describing at least one type of foam and which, accordingly, and according to said file describing the object, controls introduction of said at least one type of foam into the interior.

### CROSS-REFERENCE TO RELATED APPLICATIONS

This application is a U.S. National Stage application under 35 USC 371 of International Application No. PCT/IL2022/051298, filed Dec. 7, 2022, which claims the benefit and priority of U.S. Provisional Application No. 63/286,688, filed Dec. 7, 2021. The entire contents of each priority application is incorporated herein by reference

### FIELD OF THE DISCLOSURE

The present invention relates generally to filling objects, and more particularly to introducing industrial foam into objects.

### BACKGROUND OF THE DISCLOSURE

Many types of industrial foams and applicators for such foams, are known.

Mass customization in building is described e.g., here: https://scholarsarchive.byu.edu/cgi/viewcontent.cgi?article=8425&context=etd.

The following online publication: https://ncfi.com/content/uploads/2014/07/Estimating_Guide_for_NCFI_Spray-in-Place_Polyurethane_Systems_120610_Mod.pdf describes inter alia volume computation for a simple box which is evenly (homogeneously) filled.

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF THE DISCLOSURE

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide a method and system for controlling confined space expanding foam application which typically facilitates application of expanding foam to a confined space. The terms “apply”, “introduce” and “insert” may be interchanged herewithin.

Certain embodiments seek to provide a system for introducing foam e.g., expanding foam or spray foam into any suitable assemblies (e.g., walls, doors, windows, etc.); it is appreciated that some foams are obtained by mixing plural chemicals, and, once this mixing occurs, the resulting material expands to a larger volume than the material occupied at the moment of mixing.

Expanding foam materials (aka spray foam) are widely used in various industries for creating, for example, insulation regions, typically either as an add-on layer over, or as a fill-up area within, structures and assemblies.

Certain embodiments seek to overcome all or any subset of the following problems. Foam overloading may be a problem if an excess of foam materials leads to spill-out or distortion of unit boundaries due to foam expansion. Foam underloading may be a problem because there may be insufficient foam materials which lead to degraded performance (e.g., poor insulation, thermal leakage, structural shifting) and non-homogenous performance. Imbalanced injection may pose a problem when the injection process is fully or partly unaware of the internal geometry of the unit. Certain regions of the unit may be either overloaded, or underloaded e.g., because the foam didn't occupy the space it was supposed to. Rotation or changing of the unit's orientation may occur e.g., because various spaces or regions of the unit's interior cannot all be filled using only one orientation. If there is a limitation that no orientation change may be applied, the result may be less than all spaces being filled and/or certain spaces are only partially filled, limitations may be imposed on the use of different foaming materials, according to certain embodiments. In other cases, in which certain regions should not be filled with foam, but were eventually exposed to it, this may lead to unit damage or malfunction.

Certain embodiments seek to provide a method for introducing foam into an object's interior, including providing an injection plan with at least two stages, and, typically, performing the injection plan on at least one occasion, including, in the first stage, filling a first portion of the interior with foam while the object is in a first orientation, then typically waiting for the foam to harden, and then, in the (at least) second stage, flipping the object at least once, from the first orientation to a second, different orientation, and filling at least a second portion of the interior with foam. For example, a jig (or XY stage or XYZ stage) used while an object is being fabricated may be used to perform the flipping operations.

If, for, example an object's interior includes first and second portions whose main planes are perpendicular to one another, the first orientation may be such that the first portion's main plane is normal to the ground, whereas the second orientation may be such that the second portion's main plane is normal to the ground, thereby to ensure that, due to gravity, the first and second portions are each entirely filled with foam (in the first and second stages respectively).

The term “jig” as used herein is intended to include any gripper which guides a workpiece and/or tool into a proper location and/or orientation and/or ensures the workpiece and/or tool maintain proper location/s and/or orientation/s while the tool (e.g., foam applicator) applies a machining operation (e.g., foam application operation) to the workpiece (object being formed e.g.). Example types of jigs include Template jigs, plate jigs, Angle-plate jigs, Leaf jigs, and Diameter jigs.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed offshore relative to P, or “on a cloud”, and so forth.

In some embodiments, a fabrication method comprises providing a digital file storing metadata describing an object having an interior; and/or providing a hardware processor which is configured to access foam specification data which may describe at least one type of foam and which, accordingly, and/or according to the file describing the object, controls introduction of the at least one type of foam into the interior.

In some embodiments, the digital file comprises a digital precursor of the object, according to which the object is to be manufactured.

In some embodiments, the processor is configured to estimate an amount of foam to be injected.

In some embodiments, the processor is configured to determine a rate of foam introduction at at least one point in time.

In some embodiments, the fabrication method comprises providing data regarding characteristics of at least one foam applicator, such as foam introduction rate/s supported by the applicator.

In some embodiments, the rate of foam introduction is computed in real time or near-real time.

In some embodiments, an object fabrication system comprises: a digital file storing metadata describing an object having an interior; and a hardware processor which is configured to access foam specification data describing at least one type of foam, and which, accordingly, and according to the file describing the object, controls introduction of the at least one type of foam into the interior.

In some embodiments, the processor is in data communication with a sensor which provides the system with temperature data e.g., ambient temperature at time of foam injection, and wherein, responsively, the processor computes e.g., in real time or in near real time, how much foam to introduce.

In some embodiments, the digital file includes an indication of at least one trajectory along which a foam applicator travels when filling the object with at least one respective type of foam.

In some embodiments, the system provides a signal controlling a rate at which a foam applicator injects foam, at each of plural points in time.

In some embodiments, the rate is pre-computed as a function of time.

In some embodiments, the signal controls the foam applicator to inject foam at a first rate when deployed at a first height at which the volume's cross section is C1, and to inject foam at a second rate, lower than the first rate, when deployed at a second height at which the volume's cross section is C2 which is smaller than C1.

In some embodiments, the system re-computes the interior's cross section at each of plural heights, for each of plural instances of the object, including subtracting cross-sections of interior elements which are present in some instances from among the plural instances, and are absent in other instances from among the plural instances.

In some embodiments, the same trajectory is used when filling any instance of the object, irrespective of which internal elements are or at not provided within that instance of the object, and wherein the applicator's rate of injection, as the applicator moves along the trajectory, is determined for each individual instance of the unit, taking into account that each instance of the object may include a different set of internal elements whose cross-sections, at each point in the trajectory, are all subtracted from the object's cross-section at the point, to yield a cross-section which is to be filled with foam, which is specific to the point and to the individual instance, and the rate of injection at each point in the trajectory is determined as an increasing function of the cross-section which is to be filled with foam, specifically for the individual instance.

In some embodiments, a computer program product, comprises a non-transitory tangible computer readable medium having computer readable program code embodied therein, the computer readable program code adapted to be executed to implement a fabrication method comprising providing a digital file storing metadata describing an object having an interior; and configuring a hardware processor to access foam specification data describing at least one type of foam and which, accordingly, and according to the file describing the object, controls introduction of the at least one type of foam into the interior.

In some embodiments, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation, or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g., BLE) or wired (e.g., USB)), a computer program stored in memory/computer storage.

The term “process” as used above is intended to include any type of computation or manipulation or transformation of data represented as physical, e.g., electronic, phenomena which may occur or reside e.g., within registers and/or memories of at least one computer or processor. Use of nouns in singular form is not intended to be limiting; thus, the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network or a computer network such as the Internet.

An apparatus may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, an apparatus may include a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices, or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g., chips, which may be co-located or remote from one another. Any controller or processor may, for example, comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and, alternatively, may be the same structure. A statement that an element or feature may exist is intended to include (a) embodiments in which the element or feature exists; (b) embodiments in which the element or feature does not exist; and (c) embodiments in which the element or feature exist selectively e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface, or other system illustrated or described herein. Any suitable computerized data storage e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface, or “UI” as used herein, includes also the underlying logic which controls the data presented to the user e.g., by the system display and receives and processes and/or provides to other modules herein, data entered by a user e.g., using her or his workstation/device.

### BRIEF DESCRIPTION OF THE FIGURES

Example embodiments are illustrated in the various drawings. Specifically:

FIG. 1A is an example of a manufacturable unit to be injected with foam; the unit may include various concealed subsystems aka internal elements;

FIG. 1B is similar to 1A, with the case of foam level build-up partly occupying the internal space of the unit;

FIG. 1C illustrates changes to the cross section of the unit as a function of fill up levels;

FIG. 2 provides an additional example of a unit and subsystem deployed internally to the unit, demonstrating the relationship between fill up levels and vacant volume;

FIG. 3 is an illustration which continues the example of FIG. 2 for demonstrating the relationship between fill up levels and time assuming a constant fill-up rate;

FIG. 4 illustrates the unit used in FIG. 3, flipped. Volume vs. fill-up level is demonstrated with the case of cross section changes;

FIG. 5 continues the previous example, flipped from a first orientation to a second orientation. Fill up level vs. time assuming constant fill up rate;

FIG. 6A illustrates changing the injection plan to include variable injection rates, for equalizing the fill up process with the presence of variable cross sections;

FIG. 6B illustrates an injection plan including multiple stages, unit flipped and rotated between stages;

FIG. 7 illustrates a process for estimating foam mass for a closed unit. The method of FIG. 7 typically comprises all or any subset of the illustrated operations, suitably ordered e.g., as shown;

FIG. 8 illustrates a cross section of a partly open object; and

FIG. 9 illustrates a computation of an amount of foam needed based on trajectory and cross section of the unit into which foam is to be applied; the cross section may be perpendicular to the trajectory.

Methods and systems included in the scope of the present invention may include any subset or all of the functional blocks shown in the specifically illustrated implementations by way of example, in any suitable order e.g., as shown. Flows may include all or any subset of the illustrated operations, suitably ordered e.g., as shown. Tables herein may include all or any subset of the fields and/or records and/or cells and/or rows and/or columns described.

Computational, functional, or logical components described and illustrated herein can be implemented in various forms, for example, as hardware circuits, such as but not limited to custom VLSI circuits or gate arrays or programmable hardware devices, such as but not limited to FPGAs, or as software program code, stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs, and may originate from several computer files which typically operate synergistically.

Each functionality or method herein may be implemented in software (e.g., for execution on suitable processing hardware, such as a microprocessor or digital signal processor), firmware, hardware (using any conventional hardware technology such as Integrated Circuit technology), or any combination thereof.

Functionality or operations stipulated as being software-implemented may, alternatively, be wholly or fully implemented by an equivalent hardware or firmware module, and vice versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or, more generally, by a suitable microprocessor, configured in accordance with methods shown and described herein, or any suitable subset, in any suitable order, of the operations included in such methods, or in accordance with methods known in the art.

Any logical functionality described herein may be implemented as a real time application, if, and as appropriate, and which may employ any suitable architectural option, such as, but not limited to, FPGA, ASIC or DSP, or any suitable combination thereof.

Any hardware component mentioned herein may, in fact, include either one or more hardware devices e.g., chips, which may be co-located or remote from one another.

Any method described herein is intended to include within the scope of the embodiments of the present invention also any software or computer program performing all or any subset of the method's operations, including a mobile application, platform or operating system e.g., as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory, and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary, or off-line; which is of any type or level or amount or category of volatility, differentiation, mutability, accessibility, addressability, capacity, performance and energy use; and which is based on any suitable technologies such as semiconductor, magnetic, optical, paper, and others.

### DETAILED DESCRIPTION OF THE DISCLOSURE

Certain embodiments seek to provide a hardware processor which controls human or automated insertion of foam into a cavity e.g., interior of a wall, which may be cluttered by internal elements such as pipes, electric boxes, HVAC components. Typically, the hardware processor receives inputs characterizing the cavity e.g., a 3D model of the cavity which may include 3D models and/or positions and/or orientations of any elements deployed within the cavity. Typically, the hardware processor determines an amount of foam which is to be inserted into the cavity. Typically, the hardware processor generates a roadmap or flow for insertion of the foam. The flow may include an amount of time for which a foam applicator is to operate and/or a rate of foam insertion, for each of plural positions of the applicator vis a vis the cavity to be filled with foam. For example, a first portion of the cavity which lies below a first position may be empty, whereas a second portion of the cavity, which lies below a second position, may not be empty, and may instead be filled with internal elements which occupy most of the second portion, such that less foam needs to be inserted when the applicator is in its first position vs. more foam which needs to be inserted when the applicator is in its second position. The amount of foam to be introduced may be achieved by the rate of foam insertion and/or by the amount of time the applicator spends in a given position before moving on to the applicator's next position.

According to certain embodiments, a foam applicator, being used to fill a cavity, move along a trajectory at an even speed, and, at each position along the trajectory, a rate of foam introduction is employed which is selected as an increasing function of the cross-section of the cavity or volume at that point, such that as the applicator moves through a first area with a first cross-section, foam is introduced at a first rate, high enough to ensure that the entire first area is filled with foam, whereas when the applicator moves through a second area with a second cross-section smaller than the first cross-section, foam is introduced at a second rate which is lower than the first rate, to fill the second area, but also prevent over-filling.

It is appreciated that foam, despite being subject to gravitational force can fill a cross-section some of which is above the applicator/injector trajectory because the foam type may expand. For example, at time t=T the injector nozzle may be at a location X and some foam will then be injected and start to expand immediately after. At time t=T+dt when the nozzle is at location X+dX, more foam will be injected which will also expand, and so forth for additional locations along the nozzle trajectory.

The roadmap or flow may, for example, include orienting the cavity in a first orientation, e.g., first surface partially enclosing the cavity below a second surface partially enclosing the cavity, and subsequently, perhaps, in a second orientation e.g., second surface below first surface, or first and second surfaces perpendicular to the ground. Orientations may be selected to ensure that gravitational force guides the foam into spaces between elements deployed within the cavity, given that these spaces may have various orientations. Alternatively, or in addition, orientations may be selected to provide layers of foam. For example, it may be desired to provide, say, a wall having a structural layer, thermal insulation layer, acoustic insulation layer, and fire retardation layer. The wall may then be oriented such that its main (largest) plane lies parallel to the ground; then a first layer of foam providing, say, thermal insulation, may be inserted, then (typically after the first layer expands and/or hardens) a second layer of foam providing, say, acoustic insulation, may be inserted, then (typically after the second layer expands and/or hardens) a third layer of foam providing, say, fire retardation, may be inserted and allowed to expand and/or harden.

The system may receive as an input, or may have metadata describing, a desired thickness of each foam layer e.g., 1 cm thick layer of fire retardation foam vs. 4 cm thick layer of a structural foam.

Regarding the flow, typically the hardware processor determines how much foam is inserted into the cavity in each stage of the flow. For example, a first amount of foam may be inserted while the cavity is in its first orientation, and a second amount may be inserted after the cavity has been brought to its second orientation. And/or, a first amount may be inserted, then a hiatus may be initiated to allow the first amount of foam to expand and/or harden, and then, after the hiatus, a second stage of insertion may occur in which a second amount of foam is inserted into the cavity. For example, the system may select a hiatus which is long enough to allow foam inserted in a first stage to harden, before the cavity's orientation is changed as part of a second stage of foam insertion.

Typically the hardware processor determines which types of foam are inserted (and typically in which order) e.g. by selecting one of plural types of foams whose characteristics are stored in memory, and/or the processor may receive inputs determining which types of foam are to be inserted, and may then access, from memory, characteristics of each type of foam and, accordingly, may determine the roadmap or flow for inserting these foams e.g. which should be inserted first, how much of each type to insert, and how long to wait between inserting one type of foam and inserting the next type. For example, foam characteristics which are stored may include each foam's expansion factor F (final foam volume=F×liquid size) and/or expansion time (time required for foam to expand to its final volume) and/or time required for each type of foam to harden.

It is appreciated that different foam types may have vastly different expansion factors. For example, some foams may expand to 30 times the original, e.g. liquid size, whereas other foams may expand to 300 times the foam's original size.

It is appreciated that expansion factors may be temperature-dependent; the road-map or flow may include measuring an ambient temperature at the site of foam insertion, or may include bringing the site or the foam to a given temperature, before foam insertion. Then, the amount of foam required may be computed based on the foam's expansion factor and the volume to be filled. Another foam characteristic, which may be stored, is properties provided by the foam such as thermal insulation, or acoustic insulation, or fire resistance. The system may also store foam applicator characteristics, such as the rate of foam provided per unit time by a certain applicator such that the amount of foam required may be converted by the system into a time interval, e.g. number of seconds for which a given applicator is to be operated, to achieve this amount of foam. The terms “applicator” and “injector” may be interchanged herein, and may refer to hand-operated foam insertion devices (such as sprayers, dispensers, guns, or cannons) or to foam insertion devices (such as sprayers, dispensers, guns, or cannons) which are automated and computer-controlled. It is appreciated that foam insertion devices may be integrated with a foam receptacle, such as a can of spray foam.

It is appreciated that in mass customization use-cases, each of a set or sequence of construction projects may include housing units (e.g., for single families or individuals) of plural types, and each such unit may have several wall types, including those in which each room is provided with 6 walls (including the room's ceiling and floor). For example, if a project includes multiple buildings which each have several floors, each floor may have several apartments of different types.

According to an embodiment, walls are produced in a factory, and foam is injected into the walls, in the factory.

The system herein may have a selectable wall-filling mode of operation which typically supports providing plural layers of plural different types of foam. The system herein may have a selectable foam-layers filling mode of operation.

Temperature sensors may measure and supply to the system, storage temperatures of foam raw materials, since such temperatures may affect performance when the raw materials are combined into a foam which may occur just before or even while the foam is being introduced. It is appreciated that pieces such as, say, doors and windows for a building project, which are manufactured and filled with foam e.g., as described herein, may be marked with an ID e.g. barcode or printed label to facilitate subsequent on-site assembly.

Certain embodiments herein provide for automating (or partly automating) a foam injection process, including estimating the amount of foam and the rate of injection at various points in time. This problem becomes even more pressing when the injection is applied to a closed object. A closed object is intended to include any manufacturable unit, most or all of whose internals are typically not accessible or visible, and injection can typically only be made through some dedicated entry point. The unit may have gone through various manufacturing stages, and, at some point, foam injection may be required. A closed object, on its own, may contain concealed sub-systems or other regions e.g., MEP elements deployed within a manufacturable wall, such as electrical junction boxes, or HVAC equipment; these which may impose additional guidelines or restrictions on the injection process e.g., reducing the volume space or concealing certain portions of the volume space. Also, although it is apparent that a closed object, unless transparent, normally conceals its internals, there are other manufactured objects (not closed, or partly closed) in which estimation of foam quantities and injection rate may be desirable for an automation process, and these may benefit from embodiments herein as well.

A description of the manufacturable unit to a high level of detail may be available to the system as a result of computer aided design (CAD) software which may have been used to generate a design file according to which the unit is being manufactured. Today there are many elements in the market which offer both 2D and 3D design capabilities, such as Revit (from Autodesk). No matter which CAD software is being used, the end result is a digital file containing the data records of the design. Each CAD software may have its own file formats, but may also support common formats to allow for exporting and importing e.g., of related data structures.

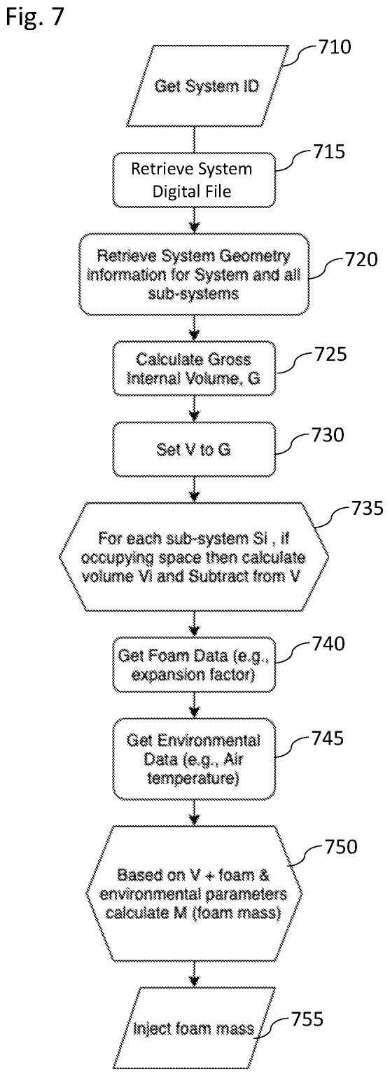

The digital file of the manufacturable unit (DFU or “system digital file”—it is appreciated that the unit being manufactured is termed the “system” in FIG. 7) may include all or any subset of the following information:
1. Various external and internal geometry related information (geometry, angles, etc.)
2. Unit metadata such as unit's unique ID
3. Hierarchical descriptions of various sub systems e.g., internal elements and layers, typically following a uniform e.g., pre-defined record structure which may also be followed for the unit itself; and
4. Meta data which may be required for various assembly stages. For the foam injection process, data such as, but not limited to, fill up regions, fill up levels, foaming materials, positioning plans (e.g., how to orient the object being filled, at each stage) may all be designated. For example, if the injected space consists of 3 adjacent compartments A, B, C with no physical border lines between them, and each compartment requires different foaming materials (e.g. according to the injection plan compartments A, B and C require foam materials 1-3 respectively), then the injection instructions (e.g. in the injection plan) may list 3 different orientations (A on bottom, inject foam material #1, wait T1 minutes, change orientation to C on bottom, inject foam material #3, wait T2 minutes, level space—B in the middle, inject foam material #2, wait T3 minutes, declare Ready).

More generally, it is appreciated that foam layers 1-N which may be of types 1-N may be provided by orienting the object such that the portion of the object which is to receive the first layer is at the bottom and the portion of the object which will later receive layer N is at the top, supplying the first layer, waiting for the first layer to harden, upending the object such that the portion of the object which is to receive the N'th layer is at the bottom, supplying the N'th layer, waiting for the N'th layer to harden, and then again, upending the object such that the portion of the object which has received the first, now hardened layer is on the bottom, supplying the second layer over the hardened first layer, waiting for the second layer to harden, upending the object such that the portion of the object which received the N'th layer is at the bottom, supplying the (N-1)′th layer, waiting for the (N-1)′th layer to harden, and so forth, until all N layers have been introduced.

Certain embodiments of the invention involve computing foam mass for filling a manufacturable unit e.g., to a designated fill-up level. With a closed object, one cannot estimate the available vacant volume for the foaming injection process. There is typically no practical trial-and-error option as one cannot assume that each unit is available for testing numerous times, as may be the case in mass production. Thus, in mass customization, each unit presents a new challenge to the manufacturing process.

It is appreciated that embodiments herein are not limited in their applicability to closed objects or to objects which are closed other than a slit or aperture intended for foam injection; for example, an object such as an open (aka partially closed) box or door with one of the door's 6 rectangular faces missing may be open and still define an interior e.g. the enclosure defined by the 5 rectangular faces of the door whose sixth face is missing. If an entire surface is available for foam introduction, the system herein may plan or store a trajectory defining how the foam applicator will move over the surface, typically to ensure that all areas below the available open surface, are fully supplied with foam.

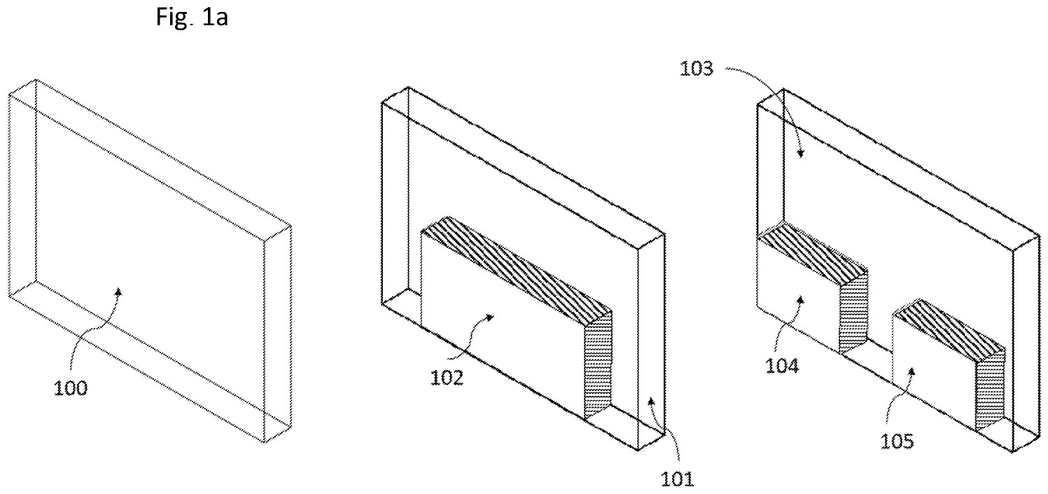

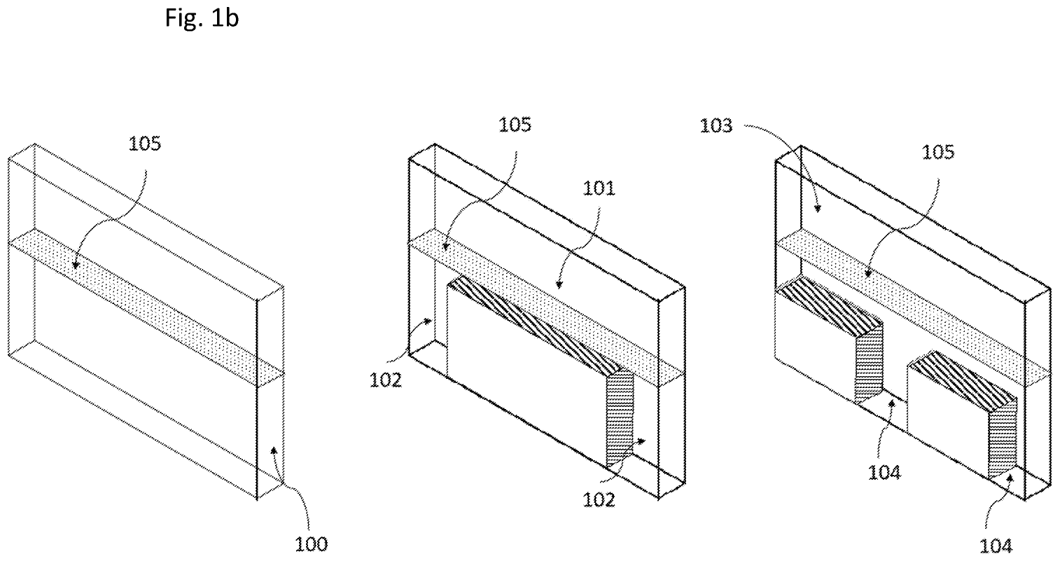

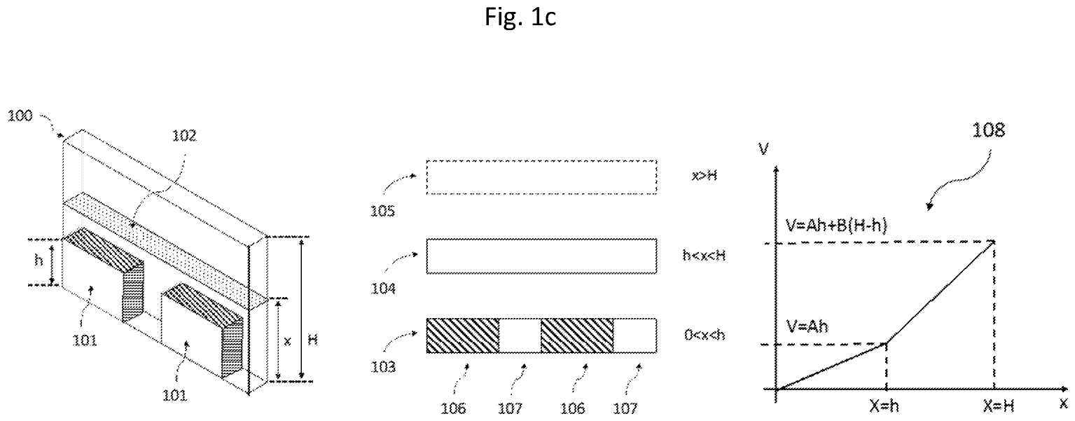

Example: In FIG. 1A, a closed unit example is presented (100). This may represent a closed wall (e.g., closed door). Based on the geometry related information (e.g., dimensions) which may be retrieved from its digital file, and the volume of the object may be computed (e.g., height×width×length). In another example within the same figure, the closed unit (101) contains a single sub-system aka “internal element” (102). Based on the information retrieved from the digital file, the gross volume of the unit (101) is computed. Similarly, the volume of the sub-system (102) is computed as well and subtracted from the gross volume. In another case, a closed unit (103) includes two sub-systems or interior elements (104) and (105) which may be concealed. Using the same technique, the unit gross volume, and the sub-systems volumes, are all computed. The volumes of the sub-systems are then subtracted from the unit's gross volume e.g., as in FIG. 1A.

In all cases of FIG. 1A, the end result is the vacant volume into which foam is to be injected.

It is appreciated that, typically, the quantity of foam is a function of (inter alia) the volume to be filled by the foam. Foam typically is introduced in either fluid/liquid or froth state, and due to a chemical reaction of its components, the foam typically expands and eventually hardens and solidifies. The expansion factors and reaction and transition times are primarily determined by the chemical components of the foam and/or may be influenced by other environmental circumstances such as ambient temperature and/or barometric pressure. According to certain embodiments, the system stores all relevant time parameters e.g., the time period or hiatus during which the foam continues to expand, and, separately, the time period (typically longer) or hiatus which is required for achieving other physical properties as hardness.

The expansion factor specification may translate foam mass units to final volume occupancy units. For example, an expansion factor of 20 cubic centimeters per gram, indicates that for every 1 gram of foam material, a final 20 cubic centimeters of space may be occupied by the expanded and hardened foam. Thus, dividing the known volume to be filled by the expansion factor yields the amount of foam mass required for injection. The expansion factor may, e.g., as described above, be influenced by air temperature, barometric pressure, and other environmental variables, and the foam manufacturer may typically specify the foam behavior as a function of these variables. Therefore, as all of these variables may be digitally measured, the expansion factor may be computed e.g., using foam specification figures; the relationship between foam behavior and various variables measured by, say, a temperature sensor or pressure sensor, may be represented in system memory, for each of plural foam options, e.g., as a graph or table or formula.

FIG. 7 is a method for introducing foam into a volume including estimating how much foam is to be introduced into the volume e.g., interior. The method of FIG. 7 may include all or any subset of the following operations, suitably ordered e.g., as shown: Get Object ID—710; Retrieve Object Digital File—715; Retrieve Object Geometry Information for object and all subsystems—720; Compute Gross Internal Volume, G—725; Set V to G—730; For each sub-system, Si, if occupying space then compute Volume VI and subtract from V—735; Get Foam Data (e.g. expansion factor)—740; Get Environmental Data (e.g. air temperature)—745; and computing foam mass e.g. based on V+foam and environmental parameters—750; compute M (foam mass)—760 and Inject foam mass—765.

### Example Implementations of the Operations May Include:

Operation 710: The unit identification number (ID) borne by the unit is retrieved by the system for the object. This may be done by barcode or RFID scanning of the object, or even by manually entering the identification information of the unit, and may, for example, involve OCR (optical character recognition).

Operation 715: a database containing the digital information of all manufacturable units is accessed and the unit's file is retrieved, using the ID. The file accurately describes the details of the specific unit to which foam is to be applied. While some units may have been manufactured according to the same design and plans, they still may vary due to various reasons such as manufacturing tolerances, deletion of certain optional elements during assembly, etc.

Operation 720: For volume computation, the geometry related information is extracted (for the unit and all of its sub-systems).

Operation 725: First, the gross internal volume of the unit is computed, designated variable G, e.g., as per the following operations.

Operation 730: A temporary variable V is initiated with the value of G (V←G).

Operation 735: the method may determine occupancy properties for each sub-system Si e.g., the sub system's structure and geometry may need to be known and their volume subtracted from the total available volume space when computing the injected volume space, sub-systems' associated volume Vi e.g., of each internal element or subsystem, may be subtracted from V. While most sub-systems occupy a physical volume, some may not exist in the specific implementation of the unit, or some are virtual elements (e.g., place holders), or some have a negligible impact (in a volumetric sense) and do not occupy any meaningful physical space to be considered by the process. Information identifying such elements may be included in the meta-data parts of the digital file of the unit. In this case Vi is set to zero (not computed). After all sub-systems have been thus processed, the V variable's value is the net or vacant volume for injection.

Operation 740: Foam specification data is retrieved which may include for example, the time-period or hiatus required for solidification of foam (e.g., as a function of temperature and/or pressure and/or cross-section and/or extent of contact with air e.g., surface area.

Operation 745: Environment data (e.g., room temperature) is measured.

Operation 750: Using the foam specifications and the environmental data, the expansion factor is computed. The net volume V is divided by this factor to yield the foam mass value M.

Operation 755: Foam mass whose value is M is loaded to the injection instrument or applicator (e.g., foam gun machine), and injection is initiated.

At some points herein it may be assumed, for simplicity, that the entire vacant volume is to be filled with the foam material; however, in fact, any level of filling may be targeted with appropriate adjustments of teachings herein. The method for estimating the amount of foam needed if the fill up process should be stopped at a certain level, may for example include defining the unit's main volume, and the volumes of any internal elements, as including only the portion of these volumes which is below the level at which foam application is to stop.

For example, in all of the closed objects (100, 101, 103) in FIG. 1B, the plan is to only partly fill the lower portion of the unit. In (100), the volume computation is based on the adjusted height of the filling level (resulting in the adjusted gross volume). In (101) which is the same unit as (100) with a single sub-system, the net volume to be filled is the adjusted gross volume, subtracting the volume of the sub-system itself. In (103), the system may (e.g., following the same process) subtract from the adjusted gross volume the volumes of each sub-system.

According to certain embodiments, a slicing technique may be employed, in which cross-sections or horizontal slices of the unit and/or its internal elements, may each be analyzed. For example, in FIG. 1C, the unit (100) includes 2 sub-systems (both 101). If the foam injection plan is to fill up the unit up to the level height x, the system may examine the cross sections as the foam level advances from the ground (zero height) up to height x. In the illustrated embodiment, the cross-section changes at some points; for example, for 0<x<h, the cross section is presented in (103). The sub-systems (101) are both seen at (106) while the areas (107) present vacant space. The total vacant area for this case is designated as A. For h<x<H, the cross section is presented in (104) thus has changed relative to cross section (103). As the height x is above both sub-systems (101) then the cross section is completely clear or needs to be fully injected with foam. The total vacant area for this case is designated as B. For x>H, the unit height is exceeded and the system may treat this as though there is no cross section or a cross-section of zero.

It may be assumed that e.g., in the process of slicing, the height x increases from 0 by small steps or increments d=H/N (where N is some large integer number). Thus, in effect, the unit is sliced horizontally into uniformly thick layers or slices (thickness d). Initially, for each step d in height, the cross-section area indicative of vacant space is A, and therefore the available volume is Ad. When x increases above h (x>h), the cross section increases to B, hence the available volume for each step increases to Bd. There is no additional volume for x>H. The system may plot the vacant volume as a function of the height x in (108) and the transition between the changes of the cross-sections are apparent. If x=h, then the vacant volume is Ah, while if x=H the vacant volume is the sum of the previous result Ah with the additional added volume of B (H-h).

Thus, a complex unit with various sub-systems may be filled with foam, including retrieving, from the digital file, geometrical properties of the unit and of all of its sub-systems, and computing the vacant volume e.g., using the slicing technique presented here.

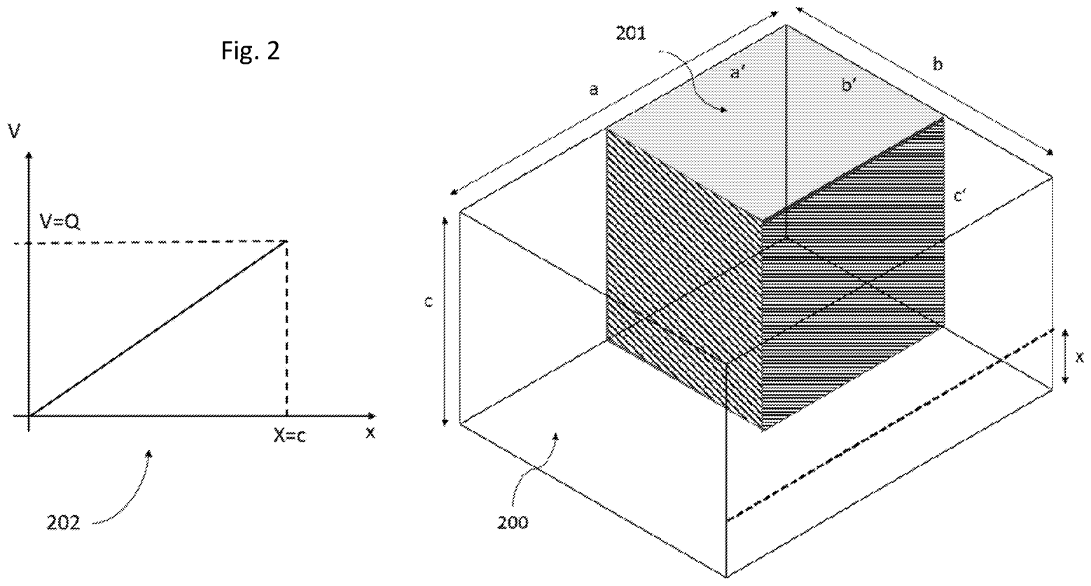

According to certain embodiments, the system is configured to, typically first, establish the relationship between rate, volume and height e.g., as shown in FIG. 2. A manufacturable unit (200) is a box (rectangular prism) with an additional subsystem (201) occupying a portion of the main unit. The dimensions of the unit are a by b by c, while the internal sub-system corresponds to a′ by b′ by c′; e.g., as described above with reference to FIG. 1C), the cross-section here is L shaped and does not change with the fill up level height x. As such, the vacant volume available for injection is a linear function of the fill up level as seen in (202). When x reaches the top level of the unit, x=c, the full available volume Q=abc−a′b′c′ is determined.

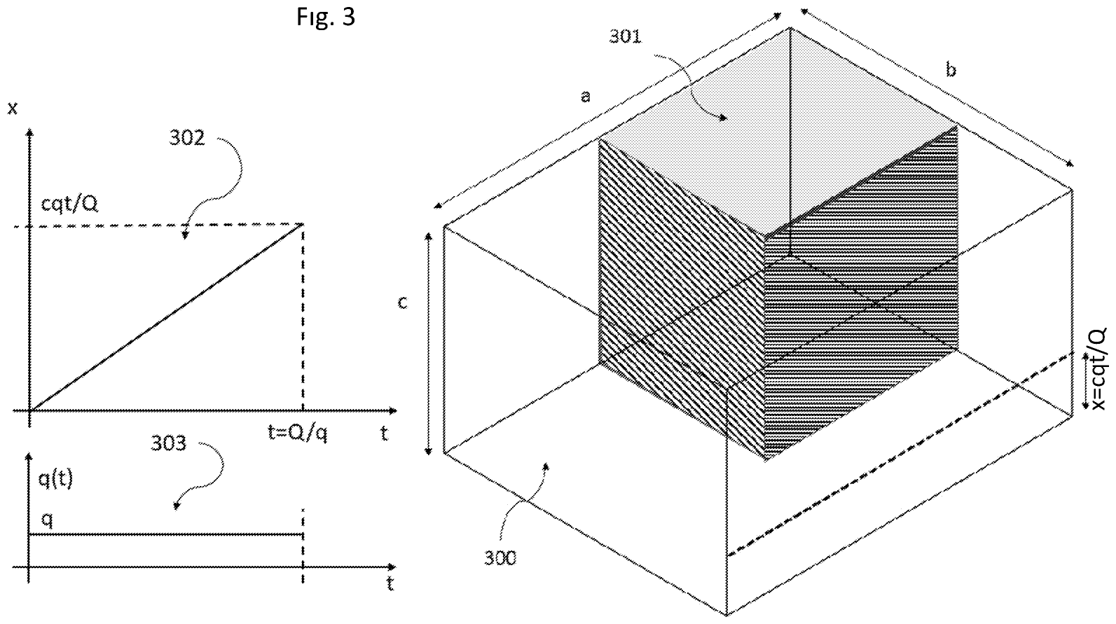

The unit is shown, as well, in FIG. 3, examining the relationship between the injection rate q. For simplicity, assume a liquid format of the foam with a 1:1 expansion factor. If the flow rate is q, then the time required to fill up the available volume may be Q/q. As the cross-section remains constant as the fill up process continues, a linear relationship exists between the level of fill up and time as seen in (302) assuming a constant rate injection as demonstrated in (303).

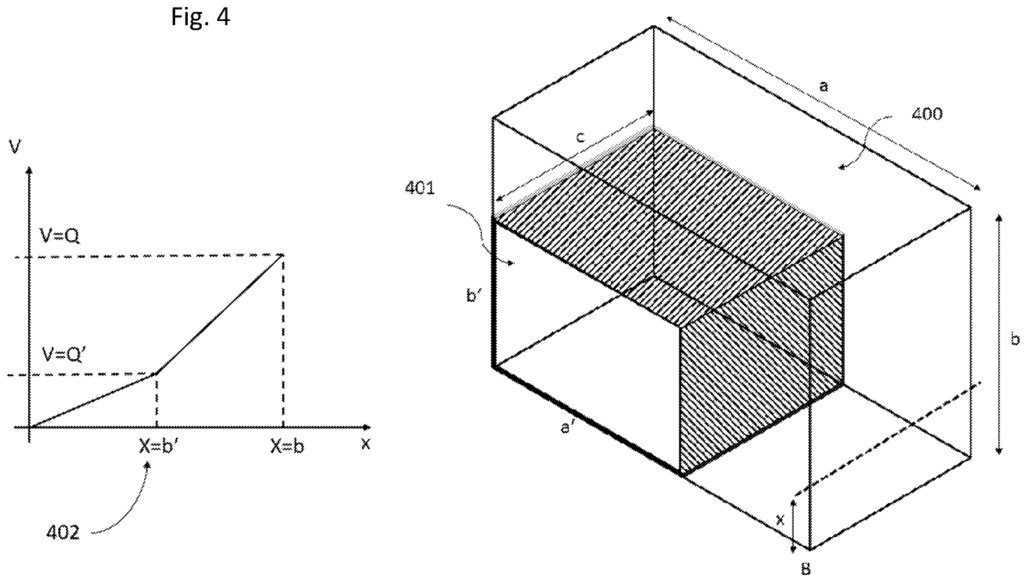

As shown in FIG. 4, the system may re-position and flip the previous unit on one of its other sides, as presented by the unit itself (400) and its subsystem (401). In this case, the cross-section changes at some point when the fill up level increases, e.g., because when x<b′ only a smaller portion of the cross section receives injected foam, as the subsystem occupies part of the unit's base or floor or bottom surface. When x>b′, the fill up level is above the subsystem's height and all of the area of the corresponding cross-section becomes available to receive foam. A graph relating between the fill up volume and the fill up height is presented in (402) demonstrating the piecewise linear relationship between the fill up volume and the fill up height, with a breakpoint at x=b′.

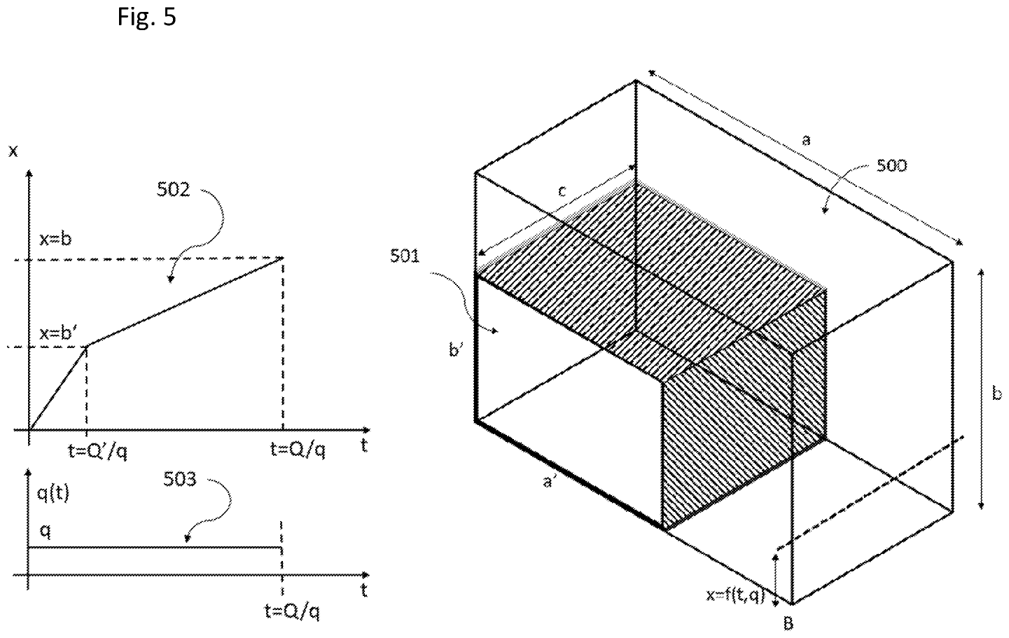

In FIG. 5, the relationship between fill up level and time again appears, assuming some constant injection rate q (see 502, 503). At first, the space to fill up is smaller and hence it fills up faster, whereas when x reaches x=b′, the remaining fill up volume is larger and fills up more slowly, due to the constancy of the injection rate.

It is appreciated that according to certain embodiments, the applicator's nozzle should move more slowly and/or eject foam at a lower rate, when the nozzle is deployed above locations (such as above interior elements 104, 105 in FIG. 1A) which are less deep hence require less foam to be ejected, relative to a higher speed and/or faster ejection rate when the nozzle is deployed above locations which are not above interior elements 104, 105 in FIG. 1A hence are deeper hence require more foam.

FIGS. 4 and 5 present a method for introducing e.g., injecting foam according to certain embodiments. The geometry of the internal closed object changes within the unit, presenting volumetric considerations while the injection process takes place. Depending on the characteristics of the foam material itself, adapting the injection rate, or even changing the materials through the injection, may be required.

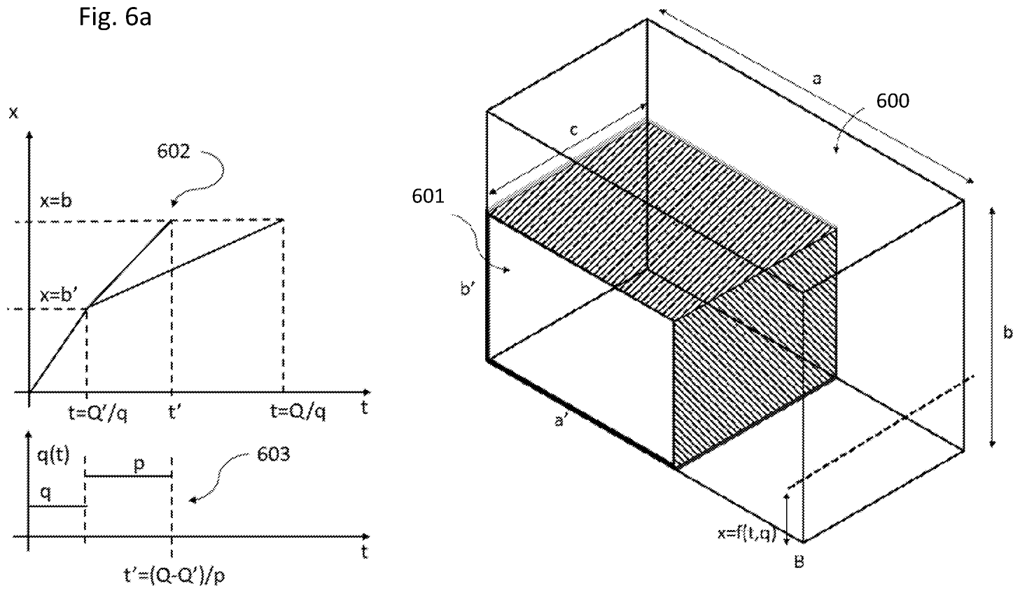

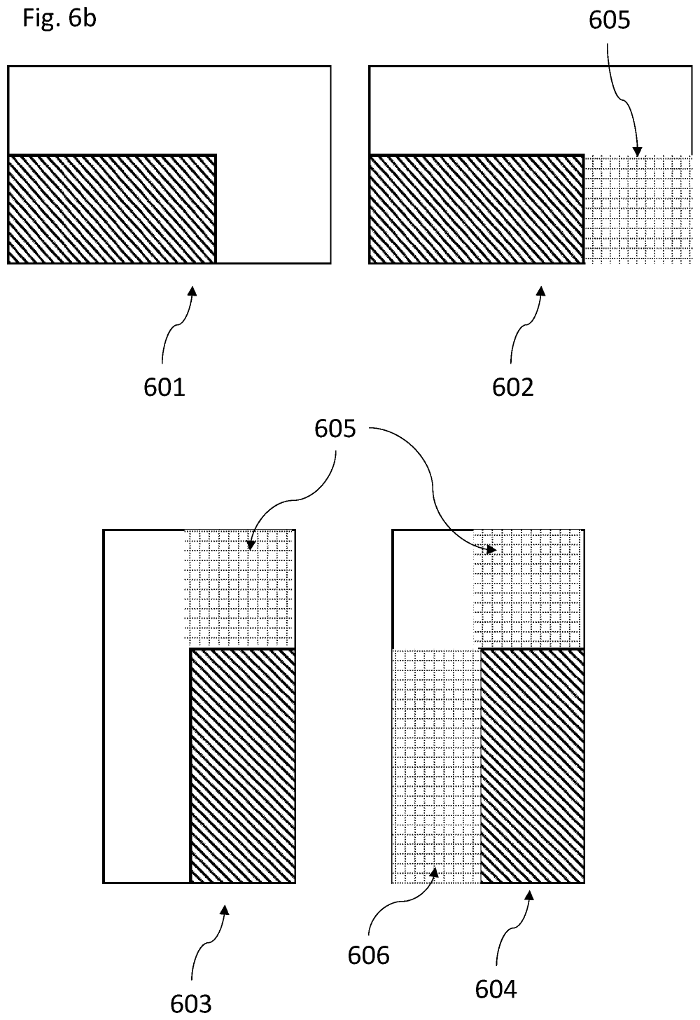

For example, some foam material and its related injection process may require the fill up to be gradual, allowing for the level buildup to be monotonously increasing. FIG. 6A presents the details of FIG. 5, with a different rate injection scheme. In the case of (603), the rate remains constant for a certain time, allowing for the foam to fill up until x=b′. At this point the injection rate is changed from q to a higher value p, expecting a slowdown in fill up rates beyond x=b′ thus linearizing the fill up process as seen in (602), hence facilitating a gradual buildup through the entire injection process.

The fill up level may be at any point, depending on the design and desired foam use. As with the volume computation examples, a similar technique for computing and estimating the injection rate applies by evaluating the cross-section changes as a function of the fill up height, it is appreciated for example that 2 volumes e.g., 2 cylinders cups may have the same volume but different cross section areas, one being taller than the other with a smaller cross section, the other being shorter with a larger cross-section. When these 2 volumes are filled at the same rate, the fill up level height at a given time will differ, yet the time to complete the fill up will be the same. Even at the end of the process, the fill up levels, given the same injected quantity of foam materials, will differ as one cup is taller than the other). It is appreciated that, for example, the reaction time of the injector may be R seconds, and it may be desired to ensure that the fill up level be achieved with a tolerance of p %. to achieve this tolerance with a small cross-section, a lower filling rate may need to be employed whereas a higher filling rate may be useable and still enable the tolerance when the cross-section is larger such that the fill up level rises more slowly.

It is appreciated that when a fill up level needs to be achieved, normally, the tolerance is defined on the less critical side of the fill up level. For example, if it is essential to reach the fill up level and then desirable to minimize overfilling insofar as possible, the tolerance is defined such that the unit will always reach the fill up level and will be overfilled only up to a tolerated amount, say 5% over the fill up level. Alternatively, if it is essential not to exceed the fill up level and then desirable to minimize underfilling insofar as possible, the tolerance is defined such that the unit will never be overfilled and will be underfilled only up to a tolerated amount, say 5% under the fill up level.

In addition, e.g., as described above, the use of different foaming materials may be applied for addressing specific fill up requirements and rate adjustments, e.g., slower fill up when expansion time/s is/are shorter.

For example, in FIG. 6A, one foaming material may be used for the initial fill up until x=b′, the system may allow the foam to solidify for a given time (as defined by the material specifications), and then may apply a different foaming material for continuing the injection process for the rest of the unit.

The unit may, during its manufacturing process, be accessible by or mounted on some jig or any device that holds the unit and guides tools operating on the unit, allowing for various 3D and 2D rotations and flips which may be required in various assembly processes. Referring again to the previous example, now with FIG. 6B, begin with the front view of position (601), and then inject (602) and fill up to x=b′ (605).

The unit is then (after foam has expanded and solidified) rotated to position (603), and continue injection (606) up until a′ (e.g., as in FIG. 6A). After solidification it was able to control the foaming process to some degree, to avoid a certain region e.g., depending on the exact space geometry to be filled up and available injection points and areas). Typically, any rotation angles may be accommodated as the complete knowledge of the geometry of the unit and its internals may be known. The plans for rotating and/or shifting for supporting the injection process may be manually created or automatically created (e.g., Al) in advance, and may be part of assembly instructions which may be included in meta data associated with the unit's digital file. For example, a plan may go through all orientation possibilities (e.g., in 90-degree increments) and may e.g., for each such possibility scan the digital file of the unit searching for candidate spaces to be filled which match the current orientation/direction which was selected. For example, there may be a current space whose bottom portion matches the forces of gravity's direction and whose possible injection entry point/s is/are accessible while oriented in this direction.

There is thus provided the following method or injection plan, all or any subset of whose operations may be employed in any suitable order e.g., as follows:
aa. The digital file of the manufacturable unit is used for extracting all geometric data of the unit and its subsystems/elements typically deployed in the unit's hollow interior.
bb. The digital file of the manufacturable unit may be accessed to extract, therefrom, all meta data relevant for the foaming process which may be stored at a known location in the record. The data may include, but is not limited to, all or any subset of which regions are or are not to be filled, foam levels, foam materials chosen and their related operational parameters and characteristics, injection plans etc.
cc. The injection process includes stage/s; for each, an injection plan is available from the digital file and/or is determined by the system herein. For each stage, the positioning or orientation of the unit is set e.g., by suitable rotation of the unit and the injection material chosen.
dd. Using the volumetric knowledge as computed from the geometric data, exact volumes and injection rates are applied.
ee. Curing time (for foam solidification) is maintained prior to executing the next step of the injection plan.
ff. the unit is released (e.g., after executing all steps of the injection plan) for the next stage of manufacturing.

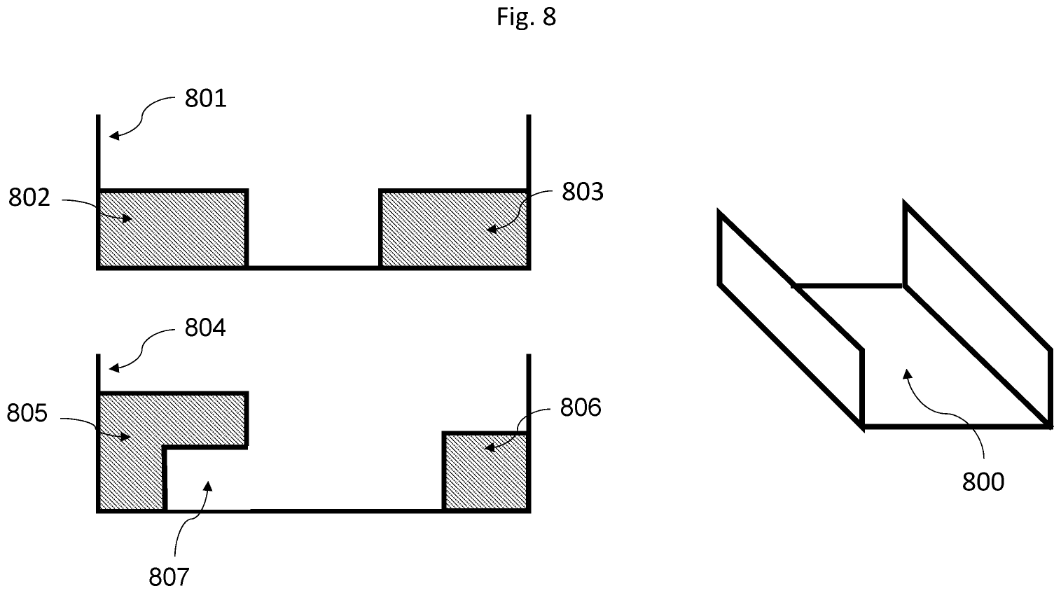

In cases where the unit is partly or even completely open, there is still a need to compute accurately the amount of foaming materials needed. In FIG. 8, a semi open rectangular prism (800) is to be foam filled; when the unit is filled from above, its internals are visible and the target filling volume may be estimated by computing the prism volume. However, in real-life scenarios, the unit structure is more complex. For example (801) presents a cross section of a unit which may be similar to (800), however there are 2 regions (802, 803) which are blocked and reduce the volume amount compared to the initial case (800). In (804), another unit is presented, however in this case the structure of the blocked regions (805, 806) may be partly visible from above (assuming the filling process is done from above) and a concealed vacant region (807) may be missed or not taken into account during the filling process.

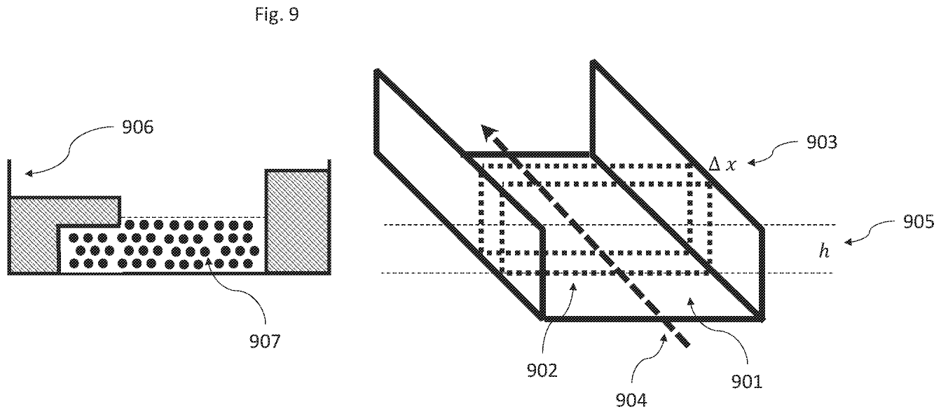

A process, which may be similar to the process previously described e.g., in FIG. 7, for computing the amount of foaming material, may be applied in this case as well. In FIG. 9, the filling process is demonstrated by the trajectory (904) of the applicator (or tip thereof). Orientation of the applicator may also be varied over time. Although in FIG. 8 the trajectory is shown as a straight line for simplicity, filling schemes may use any suitable trajectories.

Typically, the applicator or filling device moves over time (t) along the trajectory at a certain velocity V(t) and position X(t). At some points, the velocity may be zero as the applicator stops to fill a certain volume from a certain position from which the volume is accessible. At a given time, the cross-section of the unit may be estimated by retrieving the object (unit) geometry as before. The cross-section area computation typically is configured to take into account any hidden structures or blocked regions and the target filling height h (905). A typical cross section (906) includes filled areas such as (907) hence the cross-section area S(t) at a given time t may be computed precisely. The anticipated additional volume ΔP to be filled at a given small time difference Δt may be therefore ΔP−S(t) V(t) Δt. The exact amount of additional foaming material needed to fill this additional volume (taking into account expansion factors, specific density, temperature, barometric pressure etc.) may then be computed.

Thus according to certain embodiments, all or any subset of the following features are provided: The digital file of the manufacturable unit is used for extracting all geometric data of the unit and its sub systems. The digital file of the manufacturable unit is used for extracting all meta-data relevant for the foaming process. The data may include, but not limited to, regions to be filled, foam levels, foam materials chosen and their related operational parameters and characteristics, injection plans etc. The foam introduction process may include plural filling stages. In each stage, a different portion of the unit may be filled. For each unit, an injection plan is available from the unit's digital file. For each individual stage, typically in the injection plan stored in the digital file of the manufacturable unit, the positioning or orientation of the unit is set, and the unit may then, during that individual filling stage, be rotated accordingly, and the injection material is chosen. The plan may also include a trajectory for the applicator, to be used to fill the unit, or a portion thereof, during each stage. The filling trajectory includes direction and speed data which may be used for determining the position of the filling device at any given instant. The cross-section knowledge is computed from the geometric data retrieved from the object (unit) digital files. At any given moment, the cross section and height of filling is used for establishing the rate of filling material to be applied by using the expected volume increase ΔP=S(t)V(t) Δt.

The expected volume increase is translated to foam material quantity, typically taking into account factors such as but not limited to all or any subset of foam expansion parameters, temperature of material and environment, specific density figures including other parameters (such as cross-section, surface area etc.) which influence the filling/expansion rates; some of these parameters may be temperature dependent themselves. Curing time (for foam solidification) is maintained by providing a hiatus prior to executing a subsequent stage in the injection plan. After executing all stages of the injection plan, the unit may be released for the next stage of manufacturing.

According to certain embodiments, the injection plan for a given unit is operable, irrespective of which internal elements are or are not provided within the unit. However, the rate of injection, as the applicator moves along a trajectory determined by the unit's injection plan, is typically not a fixed value. Instead, the rate of injection is determined for each individual instance of the unit, e.g., in real time or in near real-time, given that one instance of the unit may include one set of internal elements, whereas another instance of the unit may include an entirely different set of internal elements. Thus, for example, given an injection plan for a front door, if a first instance of a unit (e.g. the front door for apartment 3 on floor 1) includes no internal elements, the rate of injection used for filing the first instance with foam may be higher than the rate of foam injection used for filling a second instance of the same unit (e.g. the front door for apartment 4 on floor 1) which may include many internal elements.

Also included in the scope of the invention is any system comprising at least one hardware processor configured to carry out the process or method defined by any foam introduction plan (e.g., “injection plan”) generated and/or operative according to any embodiment herein. Such plans may, for example, call for a controller which positions an object in various orientations for various stages of the plan, e.g., as described herein.

Advantages of embodiments herein may include convenient introduction of plural types of foams which provide plural advantageous qualities respectively, such as acoustic and/or thermal insulation, structural strength, water resistance, and fire retardation, rather than resorting to a single type of foam which provides the above qualities only to an inferior degree, relative to the plural types of foams, each of which provides the above quality respectively to a superior degree—or rather than injecting a single type of foam into, say, a wall, to provide one advantageous quality, and adding additional panels externally, to achieve the remaining advantageous qualities not provided by the single type of foam.

Advantages of embodiments herein may also include facilitating mass customization e.g. because a bottleneck of mass customization may be plural, customized types of volumes which each need to be filled by foam cost-effectively by an industrial process, as opposed to, on the one hand, a single one-suits-all volume which needs to be filled by foam in an industrial setting e.g. assembly line, on the one band, and as opposed to, on the other hand, hand-filling of individual volumes which are individually manufactured for a single customer.

It is appreciated that mass customization typically uses computer-aided systems to produce custom output so as to simultaneously achieve low unit costs by using mass production processes when possible, and, at the same time, individual customization.

Mass customization is advantageous because it increases available variety and selection, while maintaining near mass production efficiency. Software-based product configurators may be provided which facilitate addition and/or modification of a core products' components and/or functionalities and/or design e.g., by producing plural variants of a single same mass-produced object e.g., building. Typically, software which interacts with customers, such as housing unit purchasers, are configured for collecting and translating user preferences into system-understandable data, and may propose, to users, plural designs all based on a single set of components.

The construction industry, which is challenged by volatility and diverse market demands, may thus provide housing units which may vary in floorspace size and internal structure.

In mass customization, the exact quantity of foam material to be used for the application and the injection plan or roadmap or flow (these terms may be interchanged herein) for injecting the foam/s, is not uniform over all housing units, and may initially be unknown.

Another advantage of certain embodiments is that provision of layers of foam is facilitated. These layers may include foams which enhance thermal insulation of a structure, which is advantageous since it is believed that over half of heat loss in heated homes occurs through the homes' ceiling or roof and walls.

Another advantage of certain embodiments is that absent embodiments herein, empty spaces which did not fill with foam, are more likely. This is believed to be undesirable for at least two reasons. First, a structure filled with foam which is not evenly distributed, and, instead, includes air spaces which may shift as time goes by, creating structural instability. Second, air spaces which are not filled with foam detract from a structure's (e.g., wall's) R value (down or “summer” R value and/or up or “winter” R value) which quantifies the structure's ability to resist heat flow from a building outward or from an environment into the building), which means that the structure becomes less effective as an insulator.

Another advantage of certain embodiments is preventing situations in which, e.g., due to a human or automated filler not knowing about certain spaces in an object's interior (e.g., spaces between internal elements deployed within the object, certain corners, or other small spaces in an object's interior, remain empty, and the foam does not enter these spaces.

Also, conventional foam introduction technology may not be suitable for closed objects having an enclosed interior e.g., walls, doors, etc.

According to certain embodiments, when an object is being filled, the object's orientation is such that the object's main surface is deployed parallel to the ground. For example, a wall being filled may lie face down, reclining on the ground, rather than standing upright. Typically, each object's closed surface/s face the ground,

While mass producing a specific unit or object (these terms may be interchanged herein), it may be assumed that all manufactured pieces (units or objects) may be identical in shape, in size, and internal structure. If foam injection is desired, then, after a few trial-and-error test cases in which the unit-specific injection process is investigated, the quantity of foam which may be needed for the application, and the proper implementation plan for the injection, may be identified and thereafter implemented for the production line. Foam quantity may remain more or less unchanged through the life cycle of the product, only with slight variations due to temperature and other environmental conditions. However, as with the case of mass customization, if the units vary in shape and/or size and/or internal structure (where internal elements are present within each unit), then the amount of foam per application may dramatically vary between units and projects. The number of variations and the quantities of each fabricated unit typically require a customized assessment of foam injection plans with the use of inaccurate manual injections based on workforce expertise.

Another advantage is that conventional systems may use an injection plan which is either unaware of concealed spaces and/or cannot change orientation for overcoming injection limitations, as the foam injection process is unaware of non-visible internal geometries of the unit e.g., of internal elements deployed therewithin. Instead, the plan may base the assessment to stop or moderate the injection process per unit (only) on parameters which are measured or viewed or sensed from the injector mechanism's perspective. This is also the case with a human guided injection process; whether conventional injection is human administered or automated, the conventional injection is non-optimal or limited due to the process being unaware of concealed spaces inside the unit such that no change in the unit's orientation is typically made during injection; if the concealed spaces are concealed then no automatic or human inspection will allow a process to infer what orientation changes or flips will result in these spaces being properly filled, whereas if the geometries of the concealed spaces are derived directly from the unit's digital file, the process can to infer what orientation changes or flips will result in these spaces being properly filled. The process may for example select, for each partially open space, an orientation o-1 in which closed surfaces of the space are on the bottom and open surface/s of the space s1 are on the top, allowing foam injection via the open surface which is on the top hence faces upward. Typically, foam thus injected is allowed to harden before the orientation is changed further, e.g., to accommodate filling of another space s2 inside the same unit, whose closed surface does not face downward in orientation o-1 and/or whose open surface does not face upward in orientation o-1. Once the foam injected while the unit is in orientation o-1 has hardened, the unit may be flipped to orientation o-2 in which space s2's closed surface does face downward and s2's open surface does face upward

Embodiments herein are advantageous vis a vis existing foam-based tiles widely used in various industries. Such tiles have predefined geometries and it is expected that they may either fill up certain areas within the unit or preferably cover them (completely, or just partially) with an additional layer of tiles. In the case of existing sub-systems within the unit, the tile may be manually cut to an appropriate size, and additionally, some of its structure may be carved out for enabling appropriate fitting. This method is well suited for mass customization projects in which the foam-based tiles may be layered to maintain some geometrical efficiency, however in contrast to embodiments herein, in other use cases the tile method translates to a manual process, not ideally suited for automated production lines, since the tile method includes a cumbersome and time consuming step, and, in many cases, is unable to tightly fit designated areas within the unit.

Certain embodiments facilitate the streamlining process of foam injection, mainly for, but not limited to, closed objects (such as closed walls, closed doors, etc. which may be filled via a dedicated entry point e.g. slit or aperture in the closed object's surface), or in cases when the object is partly closed with confined spaces, in which the exact internal structure may be partly invisible, and the exact volume space to be filled by foam is unknown or unobservable by the operator.

While existing technologies are either tuned for mass production or for customized project or prototyping, embodiments herein may handle design variations between units with no quantity pre-conditions for establishing a repeatable production line. If, for example, in a housing project which includes plural house variations, each house includes plural pre-fabricated walls of different types, the system herein may handle each wall isolation efficiently, supporting a complete, end-to-end, automated fabrication process.

Thus, embodiments herein reduce labor and/or time by automating foam introduction in accordance with embodiments herein.

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g. in software, any operations shown and described herein; information storage devices or physical records, such as disks or hard drives, causing at least one computer or other device to be configured so as to carry out any or all of the operations of any of the methods shown and described herein, in any suitable order; at least one program pre-stored, e.g. in memory, or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g., by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a network—e.g., web-based system employing software, computers, routers and telecommunications equipment as appropriate.

Any suitable deployment may be employed to provide functionalities e.g., software functionalities shown and described herein. For example, a server may store certain applications, for download to clients, which are executed at the client side, the server side serving only as a storehouse. Any or all functionalities e.g., software functionalities shown and described herein, may be deployed in a cloud environment. Clients e.g., mobile communication devices such as smartphones, may be operatively associated with, but external to the cloud.

The scope of the present invention is not limited to structures and functions specifically described herein, and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis, e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware, or software module, which is known or which is described herein to have capabilities to perform a technical operation responsive to the state or condition. The technical operation may, for example, comprise changing the state or condition, or may more generally cause any outcome which is technically advantageous, given the state or condition or data, and/or may prevent at least one outcome which is disadvantageous given the state or condition or data. Alternatively, or in addition, an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly, although not limited to, those described in the Background section or in publications mentioned therein.

Conversely, features of the invention, including operations, which are described for brevity in the context of a single embodiment or in a certain order may be provided separately or in any suitable sub-combination, including with features known in the art (particularly although not limited to those described in the Background section or in publications mentioned therein) or in a different order, “e.g.” is used herein in the sense of a specific example which is not intended to be limiting. Each method may comprise all or any subset of the operations illustrated or described, suitably ordered e.g., as illustrated or described herein.

Devices, apparatus or systems shown coupled in any of the drawings, may, in fact, be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g., iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin, can also be provided as systems and sub-units thereof. The scale used to illustrate various elements in the drawings is merely exemplary and/or appropriate for clarity of presentation, and is not intended to be limiting.

Any suitable communication may be employed between separate units herein e.g., wired data communication and/or in short-range radio communication with sensors such as cameras e.g., via WiFi, Bluetooth or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application, and the description is intended to include apparatus, whether hardware, firmware, or software, which is configured to perform, enable, or facilitate that operation, or to enable, facilitate, or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry, including any such computer microprocessor/s, as well as in firmware or in hardware, or any combination thereof.

It is appreciated that elements illustrated in more than one drawing, and/or elements in the written description, may still be combined into a single embodiment, except if otherwise specifically clarified herewithin. Any of the systems shown and described herein may be used to implement, or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement, or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g., operation described herein may have all characteristics and attributes described or illustrated herein, or according to other embodiments, may have any subset of the characteristics or attributes described herein.

1. A fabrication method comprising:
providing a digital file storing metadata describing an object having an interior; and
providing a hardware processor which is configured to access foam specification data describing at least one type of foam and which, accordingly, and according to said file describing the object, controls introduction of said at least one type of foam into the interior,
wherein foam characteristics which are stored include each foam's expansion time (time required for foam to expand to its final volume) and/or time required for each type of foam to harden,
and wherein the hardware processor receives inputs determining which types of foam are to be inserted, and then accesses, from memory, characteristics of each type of foam and, accordingly, determines a roadmap for inserting these foams including which should be inserted first, how much of each type to insert, and how long to wait between inserting one type of foam and inserting a next type.

2. The method of claim 1, wherein said digital file comprises a digital precursor of the object, according to which the object is to be manufactured,
and wherein geometries of concealed spaces in a given object are derived directly from the object's digital file, and wherein the hardware processor infers what orientation changes will result in the concealed spaces being properly filled including selecting, for each partially open space in the concealed spaces, an orientation in which closed surfaces of the partially open space are on the bottom and an open surface of the partially open space is on the top, allowing foam injection via the open surface which is on the top hence faces upward, allowing foam thus injected to harden and then changing the orientation further.

3. The method of claim 1, wherein said processor is configured to estimate an amount of foam to be injected.

4. The method of claim 1, wherein said processor is configured to determine a rate of foam introduction at at least one point in time.

5. The method of claim 1, further and also comprising data regarding characteristics of at least one foam applicator, such as foam introduction rate s supported by the applicator.

6. The method of claim 4, wherein the rate of foam introduction is computed in real time or near-real time,
wherein said rate comprises a rate of injection determined for each individual instance of the unit, given that one instance of the unit includes one set of internal elements, whereas another instance of the same unit includes an entirely different set of internal elements.

7. An object fabrication system comprising:
a digital file storing metadata describing an object having an interior; and
a hardware processor configured to access foam specification data describing at least one type of foam including each foam's expansion factor, and which, accordingly, and according to said file describing the object, controls introduction of said at least one type of foam into the interior,
wherein dividing the object's volume by the expansion factor yields an amount of foam mass to be used for an injection.

8. The system of claim 7, wherein the processor is in data communication with a sensor which provides the system with temperature data e.g., ambient temperature at time of foam injection, and wherein, responsively, the processor computes e.g., in real time or in near real time, how much foam to introduce.

9. The system of claim 8, wherein the digital file includes an indication of at least one trajectory along which a foam applicator travels when filling the object with at least one respective type of foam.

10. The system of claim 8, wherein the system provides a signal controlling a rate at which a foam applicator injects foam, at each of plural points in time.

11. The system of claim 10, wherein said rate is pre-computed as a function of time.

12. The system of claim 8, wherein the signal controls the foam applicator to inject foam at a first rate when deployed at a first height at which the volume has a first cross section, and to inject foam at a second rate, lower than the first rate, when deployed at a second height at which the volume has a second cross section which is smaller than the first cross section.

13. The system of claim 8, wherein the system re-computes the interior's cross section at each of plural heights, for each of plural instances of the object, including subtracting cross-sections of interior elements which are present in some instances from among the plural instances, and are absent in other instances from among the plural instances,
wherein, when a fill up level needs to be achieved,
when it is essential to reach a fill up level and then desirable to minimize overfilling insofar as possible, a specific overfilling tolerance value is defined such that the unit will always reach the fill up level and will be overfilled only up to the specific overfilling tolerated value over the fill up level,
whereas when it is essential not to exceed the fill up level and then desirable to minimize underfilling insofar as possible, a specific underfilling tolerance value is defined such that the unit will never be overfilled and will be underfilled only up to the specific underfilling tolerance value under the fill up level.

14. The system of claim 9, wherein the same trajectory is used when filling any instance of the object, irrespective of which internal elements are or at not provided within that instance of the object, and wherein the applicator's rate of injection, as the applicator moves along the trajectory, is determined for each individual instance of the unit, taking into account that each instance of the object may include a different set of internal elements whose cross-sections, at each point in the trajectory, are all subtracted from the object's cross-section at said point, to yield a cross-section which is to be filled with foam, which is specific to said point and to said individual instance, and the rate of injection at each point in the trajectory is determined as an increasing function of the cross-section which is to be filled with foam, specifically for said individual instance.

15. A computer program product, comprising a non-transitory tangible computer readable medium having computer readable program code embodied therein, said computer readable program code adapted to be executed to implement a fabrication method comprising:
providing a digital file storing metadata describing an object having an interior; and
configuring a hardware processor to access foam specification data describing at least one type of foam and which, accordingly, and according to said file describing the object, controls introduction of said at least one type of foam into the interior,
wherein foam characteristics which are stored include each foam's expansion time (time required for foam to expand to its final volume) and/or time required for each type of foam to harden and wherein the hardware processor receives inputs determining which types of foam are to be inserted, and then accesses, from memory, characteristics of each type of foam and, accordingly, determines a roadmap for inserting these foams including which should be inserted first, how much of each type to insert, and how long to wait between inserting one type of foam and inserting a next.
